(19) United States
(12) Patent Application Publication
(10) Pub. No.: US 2010/0276218 A1
(43) Pub. Date: Nov. 4, 2010

(54) HYBRID ELECTRIC VEHICLE POWERTRAIN HAVING HIGH VEHICLE SPEED ENGINE STARTS

(75) Inventors: Wayne Michael Thompson, Northville, MI (US); Jimmy H. Kapadia, Ottawa Hills, OH (US); Thomas Scott Gee, Canton, MI (US); Joseph Gerald Supina, Saline, MI (US); Allen Dennis Dobryden, Ann Arbor, MI (US); Tamilvanan Arunachalam, Kalamazoo, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/431,800

(22) Filed: Apr. 29, 2009

(51) Int. Cl. B60W 10/06; B60W 20/00

(52) U.S. Cl. 180/65.28; 180/65.275

(57) ABSTRACT

A hybrid electric vehicle powertrain includes an electrical power source with an electric motor, a generator and a battery. A mechanical power source is an engine with a direct-start fuel injection feature. The direct-start feature provides engine starting torque at high vehicle speeds during a transition from a fully electric drive mode to a drive mode using both power sources.

### BACKGROUND OF THE INVENTION

1. Field of the Invention

The invention relates to hybrid electric vehicles having an all-electric drive mode.

2. Background Discussion

A hybrid electric vehicle powertrain for automotive vehicle having power split characteristics is disclosed in prior art U.S. Pat. No. 7,285,869, which is owned by the assignee of the present invention. That hybrid electric vehicle powertrain has an engine, typically an internal combustion engine, a planetary gearset, a generator, a motor and a battery. The motor is drivably coupled to vehicle traction wheels. The generator is mechanically connected to the sun gear of the planetary gearset and the ring gear of the planetary gearset is drivably connected through transmission gearing to the traction wheels. The carrier of the planetary gearset is mechanically connected to the engine.

A powertrain configuration of this type may have a power-split power flow path to traction wheels from two power sources. The first is a mechanical power source comprising an engine coupled by gearing to traction wheels, and the second is an electric drive system comprising the motor, the generator and the battery, the motor being drivably connected by gearing to the traction wheels. The battery provides motive power and energy storage for the generator and the motor. Both power sources share elements of the gearing as power flow paths to vehicle traction wheels are established.

During operation of the powertrain in a fully electric drive, the engine is turned off. When the battery state-of-charge begins to be depleted during fully electric drive, the engine may be started using generator torque since the generator is mechanically coupled to the engine through the gearing.

A powertrain of this type will not allow the engine to start using generator torque at vehicle speeds above a certain value. This constraint is primarily due to the power/torque characteristics of an electric machine; i.e., a generator or motor. Electric machine torque typically decreases as speed increases. Thus, the electric machine may not be able to produce enough engine cranking torque at high speeds to enable the electric machine, acting as a motor, to drive the engine at a cranking speed.

### SUMMARY OF AN EMBODIMENT OF THE INVENTION

Because of the torque limitations of the generator during an engine start at high vehicle speeds, a direct-start fuel injection engine is used to develop engine cranking torque. This will avoid the need for using torque from the electric power source that would be necessary to start the engine. It also allows a higher calibration set point for using the all-electric drive function. This, in turn, results in improved fuel economy because of the increased duration in a driving event in which full electric drive is used. The engine uses a direct-start injection and ignition technique to obtain engine cranking torque at high vehicle speeds when the vehicle is in a driving mode in which power must be delivered to vehicle traction wheels from each power source.

Another advantage of the invention is that the engine may be started during a driving event at both high vehicle speeds and low vehicle speeds.

### BRIEF DESCRIPTION OF THE DRAWINGS

FIG. 1 is a view of a power split hybrid electric vehicle powertrain capable of using the present invention;

FIG. 2 is a schematic view of a direct-start fuel injection engine that may be used in the powertrain of FIG. 1; and

FIG. 3 is a plot of shaft torque versus rotational speed for a typical electric machine.

### PARTICULAR DESCRIPTION OF AN EMBODIMENT OF THE INVENTION

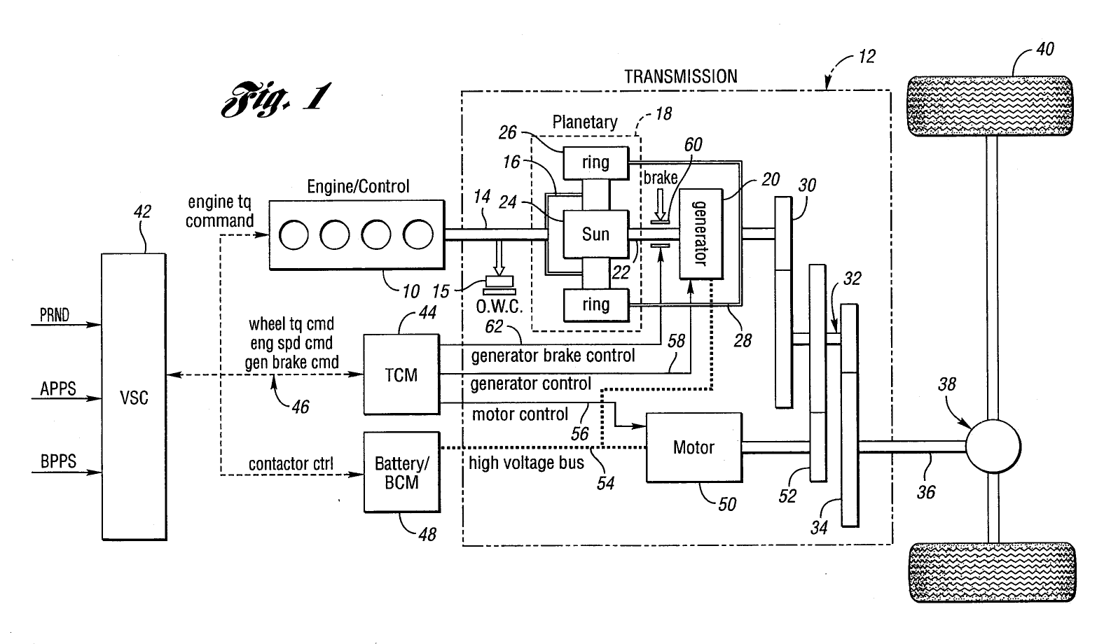

FIG. 1 is a schematic diagram of a power split hybrid electric vehicle powertrain capable of carrying out the control functions of the invention.

The powertrain configuration of FIG. 1 includes an internal combustion engine 10 and a power transmission 12. The crankshaft of the engine 10 is connected drivably by transmission torque input shaft 14 to the carrier 16 of a planetary gear unit 18. An electric generator 20, which, as mentioned previously, may act as a motor under certain operating conditions, is connected mechanically by shaft 22 to sun gear 24 of planetary gear unit 18. Carrier 16 rotatably supports pinions that engage sun gear 24 and planetary ring gear 26.

A torque transmitting element 28 transfers ring gear torque to torque input element 30 of countershaft gearing 32. A torque output gear element 34 of the countershaft gearing 32 is connected drivably, as shown at 36, to a differential-and-axle assembly generally indicated at 38, whereby torque is transferred to vehicle traction wheels 40.

A vehicle system controller (VSC) 42 is electrically coupled to a transmission control module (TCM) 44 and to a controller for engine 10. Torque command signals are distributed by the vehicle system controller through signal flow paths, generally indicated at 46, to the engine controller. Signal flow paths 46 provide signal communication also between the vehicle system controller 42 and the transmission control module (TCM) 44 and battery control module (BCM) 48.

The generator 20 is electrically coupled to electric motor 50. The rotor of motor 50 is mechanically connected to motor torque input gear 52 for the countershaft gearing 32. The electrical coupling between the generator 20 and the motor is provided by a high voltage bus 54, powered by the battery and battery control module 48.

The transmission control module is in communication with the motor 50 through motor control signal flow path 56. The generator communicates with the transmission control module through signal flow path 58. A generator brake, which is indicated at 60, is electrically connected to the transmission control module through signal flow path 62.

When brake 60 is applied, engine power may be transmitted through a fully-mechanical torque flow path from the engine, through the planetary gear unit 18 and through the countershaft gearing 32 to the traction wheel-and-axle assembly.

During normal hybrid electric powertrain operation, the brake 60 would be released and the generator 20 would apply reaction torque to the sun gear, thereby establishing parallel torque flow paths from the engine to the differential-and-axle assembly, and from the motor-generator subsystem through the countershaft gear assembly 32 to the wheel-and-axle assembly.

The powertrain system schematically illustrated in FIG. 1 may have a fully electric motor drive mode or a mode using both motor and engine power to achieve maximum efficiency. The vehicle system controller will maintain the vehicle powertrain at its maximum performance point by managing the power distribution among the various components of the powertrain. It manages the operating state of the engine, the generator, the motor, and the battery to maximize total vehicle efficiency. The battery provides energy storage for the generator and the motor.

If the state-of-charge of the battery is sufficiently high, the vehicle may be operated in a fully electric drive mode with the engine off. When the state-of-charge of the battery begins to be depleted, the vehicle system controller 42 will cause the engine to be started. In order to crank the engine when the vehicle is moving at low speeds, the generator is controlled to function as a generator by applying a torque to the sun gear, which is rotating in a direction opposite to ring gear rotation. This slows down the sun gear. The slowing of the sun gear will result in an increase of the carrier speed, which corresponds to the engine speed, assuming the ring gear speed is maintained or increased.

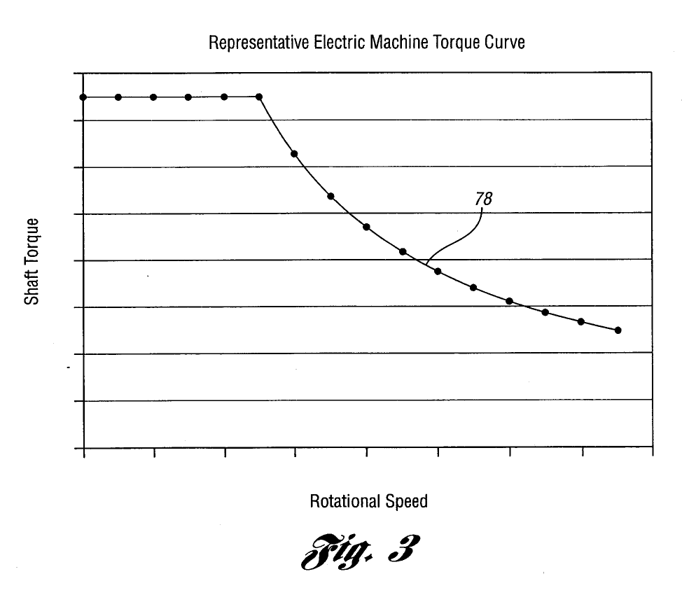

The electric motor has to provide torque to drive the ring gear as well as the vehicle. Thus, some of the electric motor power is used to crank up the engine. If the ring gear speed, which is directly related to vehicle speed, is high enough, the carrier speed, which equals engine speed, reaches the engine ignition speed before the generator speed slows down to zero. It is possible, however, that the engine speed will not reach the ignition speed due to a low vehicle speed even when the generator speed has slowed down to zero. In that case, the generator is controlled to function as a motor, turning in the direction of movement of the generator. With the generator motoring, the engine speed can reach the ignition speed. If the vehicle speed is high, however, the capacity of the generator to apply sufficient torque to start cranking the engine is diminished due to the speed-torque characteristics of an electric machine seen in FIG. 3.

The maximum vehicle speed at which the engine may be started following fully electric drive can be increased if the motor is not required to provide engine cranking torque to the ring gear through the gearing 32. If this burden on the motor is not present, the powertrain may be operated in a fully electric mode through a greater percentage of the total operating time without increasing the capacity of the motor and the battery. This is done by providing a mechanical source for power to achieve engine cranking when the vehicle speed is higher than a calibrated value. This alternate source of power, in accordance with the present invention, is a direct-start fuel injection engine, which enables the engine to be started at high vehicle speeds. This results in improved fuel economy and allows an increase in usage of a total fully electric drive mode in a given driving event.

The use of a direct-start injection engine avoids the constraint on engine starting generator torque that occurs at high vehicle speeds due to the design of a hybrid powertrain of the type seen, for example, in FIG. 1. That constraint, as stated above, is due primarily to the speed/torque characteristic of the generator, which prevents the generator from generating enough torque at high generator speeds associated with high vehicle speeds to start the engine.

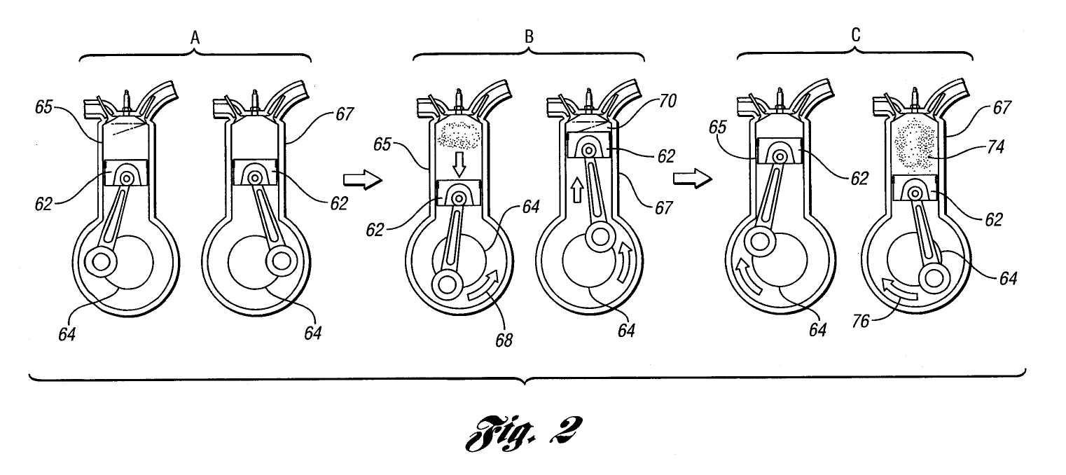

As seen in FIG. 2, the direct injection engine comprises multiple cylinders, one of which is a compression stroke cylinder shown in FIG. 2 at 65 and another of which is an expansion stroke cylinder 67. For purposes of this description, only two cylinders of a multiple cylinder engine are illustrated. Cylinders 65 and 67 are part of a multiple cylinder direct fuel injection engine that is capable of starting an engine without a starter motor.

The engine control for engine 10 in FIG. 1 uses an input signal corresponding to an engine torque command. A piston position sensor is used to identify the cylinder whose piston position is at an optimum position for a direct-start fuel injection. That position is measured in crank angle degrees after top dead center.

The engine control, using sensor input, ensures that the engine stops with each piston positioned at approximately midpoint between top dead center and bottom dead center. When the engine is signaled to start, fuel is injected into a compression-stroke cylinder 65, as seen in the compression stroke view “A” of FIG. 2. When the spark plug for that compression stroke cylinder fires, as seen in view “B” of FIG. 2, piston 62 for that piston rotates the crankshaft 64 slightly in reverse, as seen at 68. The piston for expansion-stroke cylinder 67 then is moved up because of the backward rotation of the crankshaft, as seen in view “B” of FIG. 2. Fuel then is injected into the expansion-stroke cylinder 67, as seen at 70. This compresses a fuel/air mixture charge in the expansion-stroke cylinder. When the charge is ignited, as shown at 74 in view “C” of FIG. 2, the crankshaft turns in the normal direction, as shown at 76, thereby causing normal engine operation.

The inability of an electric machine, such as the generator 20, to generate sufficient torque to crank the engine at high speeds is apparent, as previously mentioned, from the plot of FIG. 3. At high rotational speeds, the generator torque drops rapidly, as shown at 78 in FIG. 3. Because of this, the generator is not able to generate sufficient torque to cause the engine to begin cranking to start the engine.

The powertrain illustrated is one example of a power split hybrid powertrain, but the invention can be used also in hybrid powertrains with other architectures, and in so-called plug-in hybrid electric vehicle powertrains, to avoid the torque constraint described above. An electric machine need not be relied upon to provide engine starting torque when the vehicle is moving at high speeds solely under electric power.

In the preceding description of a high speed cranking feature using an engine with a direct-start injection feature at high speeds. It is possible, however, to use the direct-start injection feature to start the engine when the vehicle speed is low, as well as when the vehicle speed is above a calibrated value. There then would be a blend of motor torque and engine torque that would place a lighter burden on the generator at slow speeds. The engine then would assist the generator. The blending of the two power sources would result in a faster engine start. It may also add smoothness during a transition from an electric drive mode to a power-split operating mode or to a fully mechanical operating mode.

In still another operating mode, the direct-start injection engine may be used only at the beginning of an engine start event to overcome initial engine inertia torque and engine friction torque. This will conserve battery power. The direct-start injection engine then would be used to complement generator torque during engine cranking.

Although an embodiment of the invention is disclosed, modifications may be made by a person skilled in the art without departing from the scope of the invention. All such modifications and equivalents thereof are intended to be covered by the following claims.

What is claimed:

1. A powertrain for a hybrid electric vehicle having an internal combustion engine with reciprocation pistons in cylinders that define engine combustion chambers, an electric motor, a generator, a battery, and a gearset, the motor and the engine being mechanically coupled to the gearset;
a first torque output element of the gearset and the motor being mechanically connected to vehicle traction wheels through gearing;
the generator being connected to a second element of the gearset;
the engine being connected to a third element of the gearset;
the engine having a direct-start fuel injection feature for injecting fuel into an engine combustion chamber to start the engine during operation at vehicle speeds greater than a calibrated value to effect powertrain operation in a power delivery operating mode wherein the engine acts as a mechanical power source and the motor is part of an electric power source.

2. The powertrain set forth in claim 1 wherein the battery, the motor and the generator are electrically coupled to define the electric power source under the control of a vehicle system controller, the controller being configured to control the engine to establish with the engine a mechanical power flow path to the traction wheels following an operating mode in which only the electric power source is active.

3. The powertrain set forth in claim 3 wherein the vehicle system controller is configured to detect an optimum position for a piston in an engine cylinder near top dead center for starting the engine at high vehicle speed as fuel is injected and ignited into the cylinder to start the engine following an operating mode in which only the electric power source is active.

4. A hybrid electric vehicle powertrain having a direct-start injection engine with a vehicle system controller including a sensor for detecting positions of engine pistons when the engine is stopped, the vehicle system controller including an engine control whereby the sensor detects a position of an engine piston that is optimum for fuel injection and ignition to effect engine starting; and
a generator, a motor and a battery in an electrical power delivery path to vehicle traction wheels;
the engine being in a mechanical power delivery path to the vehicle traction wheels;
the engine being started at vehicle speeds above a calibrated value following operation using only the electrical power delivery path whereby direct-start fuel injection and ignition is used to establish the mechanical power delivery path to vehicle traction wheels at vehicle speeds greater than a calibrated limit.

5. The hybrid electric vehicle powertrain set forth in claim 4 wherein the mechanical power delivery path and the electrical power delivery path include gearing with common gear elements in each power delivery path.

6. The hybrid electric vehicle powertrain set forth in claim 5 wherein the gearing is a planetary gearset.

7. The hybrid electric vehicle powertrain set forth in claim 6 wherein the gearset includes a ring gear drivably connected to the vehicle traction wheels, a planetary carrier drivably connected to the engine and a sun gear drivably connected to the generator.
